(19) United States
(12) Patent Application Publication
(10) Pub. No.: US 2026/0120966 A1
(43) Pub. Date: Apr. 30, 2026

(54) METHODS OF FABRICATION OF ENVIRONMENTALLY FRIENDLY SUPERTCAPACITOR AND PERFORMANCE FOR REAL WORLD APPLICATIONS

(71) Applicants: Manoj Kumar Ram, Palm Harbor, FL (US); Logan Piner, Land O Lakes, FL (US); Miomir Vukmirovic, Miami, FL (US)

(72) Inventors: Manoj Kumar Ram, Palm Harbor, FL (US); Logan Piner, Land O Lakes, FL (US); Miomir Vukmirovic, Miami, FL (US)

(21) Appl. No.: 18/950,329

(22) Filed: Nov. 18, 2024

Related U.S. Application Data
(60) Provisional application No. 63/714,486, filed on Oct. 31, 2024.

(51) Int. Cl. H01G 11/86; H01G 11/24; H01G 11/34; H01G 11/36; H01G 11/38; H01G 11/48

(52) U.S. Cl. CPC H01G 11/86; H01G 11/24; H01G 11/34; H01G 11/36; H01G 11/38; H01G 11/48

(57) ABSTRACT

Our invention is about synthesis, fabrication, assembly, packaging, testing of asymmetric flexible supercapacitors utilizing bacterial cellulose, conducting polymer, activated carbon, aqueous electrolyte, having state-of-art pseudocapacitive properties; namely, high-power, high energy and high cycle life. The high capacitive performance of these types of supercapacitors is controlled by the chemical, physical, and electrical properties of the materials used for synthesis and fabrication methods for device assembly and packaging as described here-in. Bacterial cellulose is exposed as a high surface area, fibrous nanomaterial used as a source of carbon fiber for the fabrication of high-performance supercapacitor electrodes. The use of pyrolyzed bacterial cellulose, conducting polymer materials, aqueous electrolytes, non-toxic binders such as carboxy methyl cellulose dispersed in water, device fabrication, and packaging techniques produces batch production of flexible supercapacitors with high performance characteristics.

### STATEMENT REGARDING FEDERALLY SPONSORED RESEARCH

This invention was made with government support under the contract number: HQ0860-23-C-7139 awarded by Missile Defense Agency. The government has certain rights in the invention.

### STATEMENTS REGARDING FEDERALLY SPONSORED RESEARCH

Not applicable.

### REFERENCE TO A SEQUENCE LISTING

Not Applicable

### FIELD OF THE INVENTION

The disclosed technology is about biodegradable supercapacitor comprising of cathode, anode and electrolyte where asymmetric devices are fabricated, exploiting three primary electrode materials for high power performance and stability: pyrolyzed nano-cellulose, activated carbon, and conducting polymer nanocomposites. The asymmetric supercapacitor electrodes utilize high surface area activated carbon for the anodic material. The asymmetric supercapacitor cathodic materials are comprised of polyaniline (PANI) and pyrolyzed bacterial cellulose (PBC) composite resulting in a high specific capacitance material. The disclosure is about the possibility of mass production of environmentally friendly supercapacitor consists of activated carbon or pyrolyzed cellulose as anode, pyrolyzed conducting polymer composite with cellulose as cathode and acid socked glass fiber as separator.

### BACKGROUND

Supercapacitors, or commonly considered ultracapacitors, are electrochemical energy storage devices that have revolutionized the way power is delivered in both on- and off-the-grid technology [1]. Their use as state-of-the-art high-power and high cyclability devices has breached into providing capabilities for continuous rapid charging and discharging, a feature infeasible with modern electrolytic capacitor and battery technology [2, 3]. These supercapacitor characteristics yield them optimal for lightweight, low volume power solutions for reducing needed battery infrastructure to charge and operate electric vehicles, medical devices and equipment, defense, detection and communication equipment, household appliances, wearable and consumable electronics, vertical takeoff and landing aircraft (VTOL), urban air mobility (UAM), etc. In other specific circuit designs, supercapacitors have been made available to provide thermal regulation of battery operation, preventing thermal run-away and acting as an energy buffer during battery idle time, which significantly reduces battery loads and enhances battery charge/discharge properties and usage life [4].

The high capacitive performance of supercapacitors is controlled by the chemical, physical, and electrical properties of the materials used for synthesis and fabrication methods for device assembly and packaging. Vital material properties include but are not limited to excellent electrode electrical conductivity and electrolyte ion diffusivity, appropriate electrolyte-electrode interface chemistry, surface area, porosity, particle size, surface adhesion, pseudo- and double layer-capacitive behavior, corrosion resistance, and electrochemical and thermal cycling stability. Important device fabrication aspects affecting performance are the methods used for electrode deposition (rolling, aerosol, chemical vapor deposition, electrodeposition), the electrolyte used (organic or aqueous with or without ionic salts), electrode configurations (asymmetric/symmetric), packaging materials (epoxy, torsion metal/plastic casing), packaging environment (inert or ambient atmosphere, vacuum) and cell electrical connections for producing a device with the designed performance.

The currently marketed supercapacitors are typically limited to 100-200 F/g using high surface area activated carbon, graphene, etc. electrodes doped with a variety of metal oxides (MnO₂, RuO₂, IrO₂, Fe₂O₃, etc.), ultimately resulting in an expensive, corrosive, unsustainable, and non-flexible devices [4-6].

Composite conducting polymers (polypyrrole, polyaniline, poly(ortho-anisidine), polyethylenedioxythiophene, etc.) as pure materials or with graphene and/or molybdenum disulfide have shown higher specific power and specific energy-based supercapacitor and have flexible properties [7-14]

Attempts to improve performance, using non-toxic, biodegradable, and lower cost materials for supercapacitors has led to the pyrolysis and/or functionalization of macro and nano-biopolymers (cellulose, lignin, tannin, etc.) from plant matter or bacterial sources[115-17]. Supercapacitors exploiting cellulosic based materials from bacteria production entail easy scalability, lower costs than plant-based cellulose production, sustainability, and high performance from their high char density post pyrolysis with an extremely high surface area and fibrous nanostructure.

Attempts are made to fabricate the supercapacitor by optimized anode and cathode developed at PolyMaterials. The disclosure is about the possibility of mass production of environmentally friendly supercapacitor consists of activated carbon or pyrolyzed cellulose as anode, pyrolyzed conducting polymer composite with cellulose as cathode and acid socked glass fiber as separator.

### SUMMARY OF THE INVENTION

The supercapacitor invention described here-in contains a cathode, anode and electrolyte where asymmetric devices are fabricated, exploiting three primary electrode materials for high power performance and stability: pyrolyzed nano-cellulose, activated carbon, and conducting polymer nanocomposites. FIG. 1 shows the schematic of supercapacitor containing each layer.

the asymmetric supercapacitor electrodes utilize high surface area activated carbon for the anode material.

The asymmetric supercapacitor cathodic materials are comprised of polyaniline (PANI) and pyrolyzed bacterial cellulose (PBC) composite resulting in a high specific capacitance material.

Conducting Polymer stability and performance characteristics of the invention described here-in are supported through the introduction of PBC that can form a 3D network of fibers. These fibers can improve the microporosity of the polyaniline layer, thus increasing counter ion diffusion across the PANI layer thickness that is critical to the doping process of PANI. In addition, these fibers can allow room for swelling of PANI, thus improving the mechanical properties of the electrodes, leading to increased cyclability.

The anode and cathode electrodes are prepared by mixing the active materials with a low concentration of binder (carboxymethyl cellulose dispersed in water as a most suitable and sustainable option) and coated on a graphite current collector.

A cathode and anode are sandwiched together with an aqueous electrolyte-soaked separator paper (glass fiber filter paper) to provide for electrode and charge separation as well as ion transport between electrodes.

The fabricated supercapacitor may be packaged using a variety of methods and materials (epoxy, torsion metal/plastic casing, laminated metal/plastic pouches, coin cells, rolled cylindrical canisters) and packaging environments (inert or ambient atmosphere or vacuum).

The invention presented here details the materials, synthesis steps, composite compositions, electrode processing, characterization of the electrodes, assembly, packaging materials, packaging techniques, testing and the ultimate performance of the cellulose-conducting polymeric based solid state flexible supercapacitor.

### BRIEF DESCRIPTION OF THE DRAWINGS

FIG. 1. Schematic of supercapacitor and details of each layer.

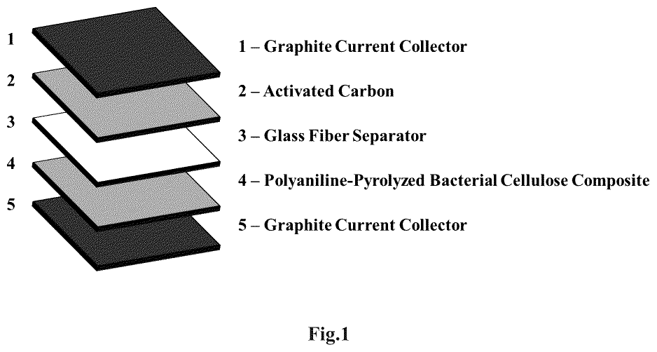

FIG. 2 is an image presenting a raw bacterial cellulose (BC) sheet produced from the culture Gluconacetobacter xylinium and dried at room temperature.

FIG. 3 is a Scanning Electron Microscopy (SEM) image of the BC revealing a nanostructured network of cellulose fibers to be exploited for composite synthesis and supercapacitive performance properties.

FIG. 4 is the temperature ramp profile for BC pyrolysis.

FIG. 5 is an SEM image of PBC.

FIG. 6 is an SEM of PANI/PBC composites with 10% PBC at a magnification of 8000×.

FIG. 7 is an image of active material ultrasonically sprayed on a graphite sheet.

FIG. 8 is an image of an electrode cutting device consisting of a guide and cutting board.

FIG. 9 is an image of a set-up for electrodeposition of copper on electrode tabs.

FIG. 10 is an image of the Cu contact covered with a Si-based dielectric grease and encapsulated with heat shrink tubing for protection against corrosion.

FIG. 11 is an image of a supercapacitor after casting in a flexible rubberized coating.

FIG. 12 is a cyclic voltammetry curve of a 45.64 F supercapacitor obtained with a scan rate of 1 mV/s.

FIG. 13 is a characteristic Ragone plot from a PolyMaterials supercapacitor. Power and energy density expressed per mass of active material.

FIG. 14 (a,b,c) shows the curves of capacitance, ESR, and leakage current of their change during the 10,000 cycles stability test.

### DETAILED DESCRIPTION OF THE INVENTION

Prior to any embodiments of the invention being disclosed, it is made known here that it is apparent to an artisan of this field of supercapacitors that the invention described here-in is not limited in its application to the details of construction and the arrangement of components set forth in the following description or illustrated in the following drawings. The invention is capable of other embodiments and of being practiced or of being carried out in various ways.

### 1. Definitions

Unless otherwise defined, all technical and scientific terms used herein have the same meaning as commonly understood by one of ordinary skill in the art. In case of conflict, the present document, including definition, will control. Preferred methods and materials are described below, although methods and materials similar or equivalent to those described herein can be used in practice or testing of the present invention. All publications, patent applications, patents, and other references mentioned herein are incorporated by reference in their entirety. The materials, methods, and supercapacitor invention disclosed herein are illustrative only and not intended to be limiting.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a”, “and”, and “the” include plural references unless the context clearly dictates otherwise. The present disclosure also contemplates other embodiments “comprising”, and “consisting of”, the embodiments or elements presented herein, whether explicitly set forth or not.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrase “at least one of A, B, . . . and N” or “at least one of A, B, . . . N, or combinations thereof” are defined in the broadest sense to mean one or more elements selected from the group comprising A, B, . . . and N, that is to say, any combination of one or more elements A, B, . . . or N including any one element alone or in combination with one or more of the other elements, which may also include, in combination, additional elements not listed.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to 4” also discloses the range “from 2 to 4”. The term “about” may refer to plus or minus 10% of the indicated number. For example, “about 10%” may indicate a range of 9% to 11%, and “about 10” may mean from 0.9-1.1%. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are explicitly contemplated.

### 2. Nano-Cellulose

Various types of food grade and bacterial based cellulose types (hypoallergenic cellulose powder, hydroxypropyl methyl cellulose, methyl cellulose, cultured celluloses) are used as possible resources of high surface area N-doped carbon after pyrolysis under an inert nitrogen or argon atmosphere (275-600° C.) for a residence time proportional to the amount of material being treated. The resulting pyrolysis of BC followed by incorporation of conductive polymer forms a solid-state, high surface area, carbonaceous nanocomposite with high-power and pseudocapacitive properties. Plant-based celluloses are typically reinforced with lignin, which is coarser in structure and difficult to separate out from the desired cellulose fibers. In supercapacitor design, high energy and power density is in part achieved by using a depositional substrate with a high three-dimensional surface area. BC is comprised of nano sized intertwining fibers that offer a large surface area for subsequent active material deposition. BC is free of lignin and tends to be much more structurally homogenous than plant cellulose.

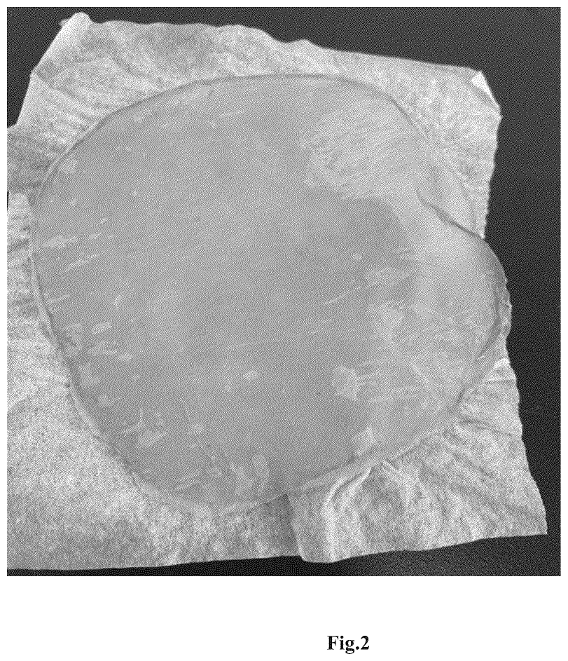

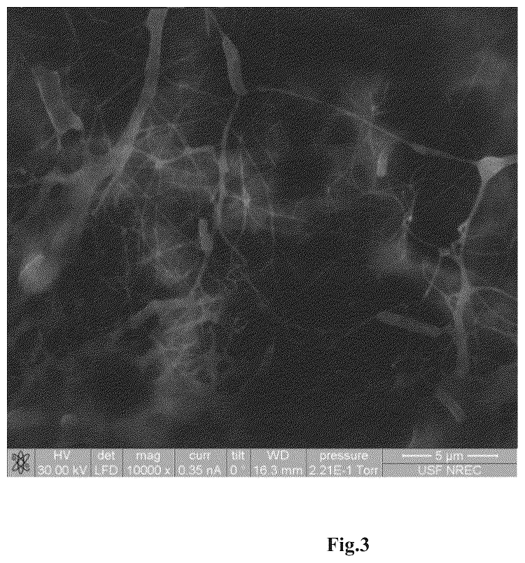

The top producer of BC in terms of fine fiber production and ease of culture is Gluconacetobacter xylinum. The high surface area BC sheet in FIG. 2 is produced by Gluconacetobacter xylinum culture in an aerated vessel, and its high surface area, nanofibrous microstructure is shown using low vacuum scanning electron microscopy in FIG. 3. Both lyophilized and un-lyophilized cellulose may be used for the supercapacitor invention described here. The BC used in this invention has been optimized through nutrient studies with the optimal broth having 6 wt. % sucrose, 0.2 wt. % yeast extract and 10 mg/100 mL yeast nitrogen base in water. Yeast is included to prevent fungal infections during cellulose growth. The synthesis process may be easily scaled for high production and helps achieve cost reductions and sustainable goals in using biodegradable and ecologically friendly materials.

### 3. High Energy Nanocomposite Synthesis

The high-power supercapacitor composite used for electrode fabrication is comprised of the conducting polymer, PANI emeraldine base (chlorinated form), and PBC. Its synthesis is described: BC was first pyrolyzed as described later. Part A slurry is prepared by mixing aniline and PBC in a beaker with appropriate amounts of hydrochloric acid (HCl), isopropyl alcohol (IPA), and de-ionized water (DI) at about 5° C. by immersing the beaker in an ice bath. The slurry is mixed until a homogenous liquid solution is produced. Approximate volume ratios of HCl, IPA, and DI to that of aniline in part A slurry are 3.6, 37.4, and 1.8, respectively and the approximate mass ratio of PBC to volume of aniline is 0.18 to achieve 10 wt. % of PBC in the final composite product. The part B solution is made with ammonium persulfate (˜0.3 g/mL) (APS) dissolved in appropriate amounts of hydrochloric acid and de-ionized water. The volume ratio of HCl to DI in this part B solution is typically 0.09. Forced mixing is used for preparing all solutions. The part B solution is poured into a separatory funnel to be added drop wise to the part A slurry, still immersed in an ice bath, at a rate of ˜1 drop/4 sec to allow for the slow polymerization of aniline and its surface adsorption on PBC. The total volume of the part A slurry is typically 4 times larger than that of the part B solution to ensure that a high yield of conducting polymer is achieved and the time required for dripping part B into part A is minimized by using a minimal part B volume. The green and crystalline emeraldine base-PBC composite is precipitated out of solution and is separated using a vacuum filtration funnel. The resulting solid nanocomposite is washed with isopropyl alcohol and allowed to air dry for 2 days.

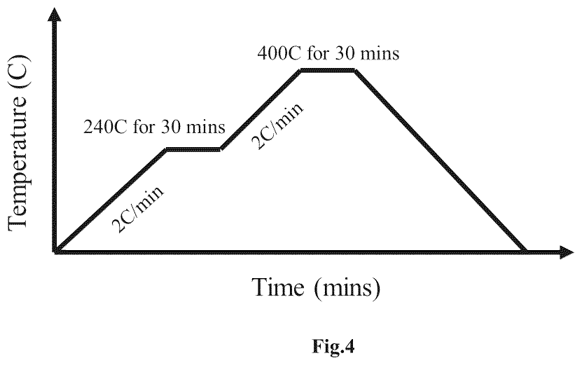

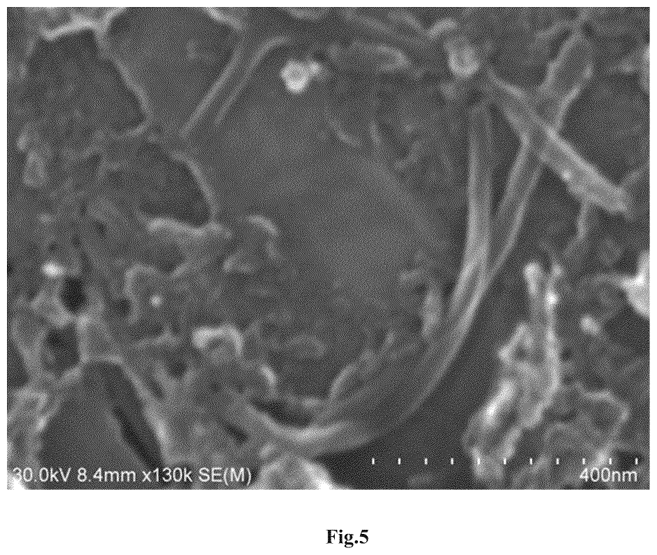

BC is produced in the form of wet pellicles. Since they contain ˜98% water, they are dried in a dehydrator before pyrolysis. This step serves to reduce the time to remove large amount of water from wet BC pellicles required for pyrolysis. Then, the dry BC pellicles were pyrolyzed in a furnace at elevated temperature under inert (N₂) atmosphere using the temperature ramp profile shown in FIG. 4. First, 5 g of dehydrated BC was placed in a quartz boat and inserted into the tube furnace. Then, the tube furnace was sealed and N₂ was allowed to flow at 100 mL per minute. This flow rate is maintained throughout the entire procedure. Then, the temperature increases from room temperature to 240° C. at a rate of 2° C. per minute. The temperature was held constant at 240° C. for 30 mins. After that, the temperature increased from 240° C. to 400° C. at a rate of 2° C. per minute. The temperature was held constant at 400° C. for 30 mins. Then, the furnace was shut down and allowed to cool to 150° C. before opening and removing the PBC. The scanning electron microscope (SEM) image of PBC shown in FIG. 5 reveals retention of the fibrous microstructure as seen in the raw material.

All raw materials and the PANI-PBC composite have been characterized using scanning electron microscopy (SEM) and electrochemical techniques. All material characterization techniques employed, including but not limited to those presented here-in, corroborate all the claims stated in this invention's description.

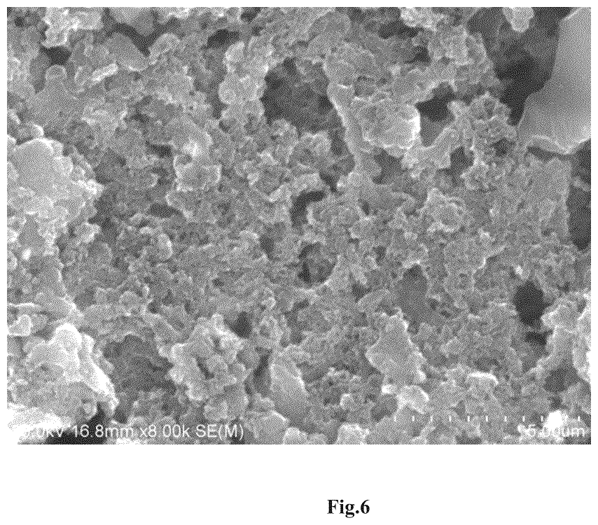

An SEM image of a resulting high surface area, high energy, solid-state, PANI-PBC composite is shown in FIG. 6. FIG. 6 reveals that by compositing PANI with PBC, a 3D network of PBC fibers is introduced into the PANI layer which improves its porosity thus improving counter ion diffusion across the PANI-PBC composite layer thickness. It should be prevalent to one who is experienced in this field that slight changes in the composition or fabrication/manufacturing techniques used for supercapacitor fabrication do not alter from the heart of the invention described here-in.

### 4. Methods of Fabricating the Flexible Electrodes

The high energy super capacitive performance of the fabricated cathodic electrode is a direct result of fabricated nanocomposite of PANI-PBC. This high surface area, granular, nanocomposite has been deposited on graphite sheet as a current collector using the aqueous soluble binder, carboxymethyl cellulose (CMC)) at 5 wt. %. The use of CMC in water as a carrier solvent for deposition of the high-energy, high-power nanocomposite on a current collector is a state-of-the-art innovation of the present invention where non-toxic chemicals are used for electrode deposition. To prepare 100 g of the slurry containing PANI-PBC in CMC dissolved in water necessary for ultrasonic spraying, first, 0.2 g of CMC is dissolved in 96 mL water. After complete dissolution of CMC in water, 3.8 g of PANI-PBC is added to the CMC-water solution and mixed for 8 hrs.

The high surface area activated carbon (AC) is used as the active material for the anode. To prepare 100 g of the slurry containing AC in CMC dissolved in water necessary for ultrasonic spraying, first, 0.2 g of CMC, 96 mL water, and 3.8 g of AC are added to a stainless-steel milling jar with 5 mm zirconium milling balls. The solution is milled at 30 Hz for 27.5 mins, after which the zirconium balls are filtered from solution.

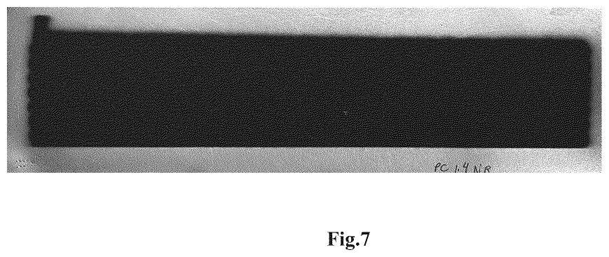

The deposition process has been conducted using a variety of techniques. The PANI-PBC nanocomposite binder slurry and the AC slurry can be deposited on a graphite current collector using a variety of techniques including using an ultrasonic sprayer, heated rolling machine, heated/ambient aerosol spray, heated/ambient press machine, thin film technique, among others. After deposition, the electrodes are allowed to dry for solvent evaporation under ambient conditions, at an elevated temperature. FIG. 7 displays active material ultrasonically sprayed on a graphite sheet using a 80° C. hot plate.

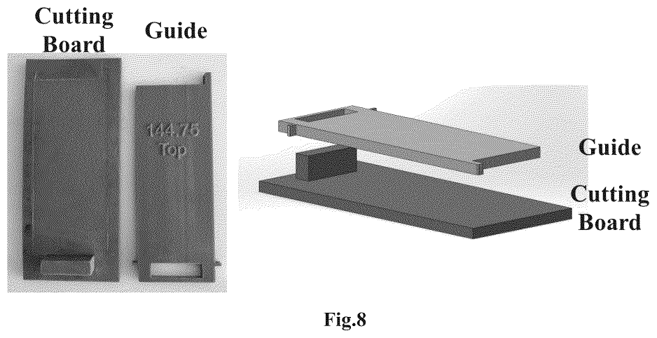

For cutting electrodes to the desirable size and to assemble them into supercapacitors, a cutter for reproducibly cutting electrodes was developed. It consists of a guide (top part) and cutting board (bottom part), FIG. 8. After the active material was deposited on the graphite sheet, such graphite sheet was placed between top and bottom parts. Then, using a razor blade, an electrode with the desirable size was cut out. The electrodes have exposed tabs extending beyond the electrolyte layer for easy connection to a conductive lead.

After electrodes were cut out, they were then hot rolled. Hot rolling serves to make the electrical contact between the active material and graphite sheet better. The hot roller was first set to 80° C. Then the thickness of each electrode (active material+graphite sheet) was measured using a caliper on several places, and the average thickness was obtained. The distance between the rolling cylinders was first set to 66% of the initial thickness of the electrode, and the electrode was passed through the roller 5 times, varying direction for each pass. Next, the distance between the rolling cylinders was set to 50% of the initial thickness of the electrode, and the electrode was passed through the roller 5 times, varying direction for each pass. Lastly, the distance between the rolling cylinders was set to 33% of the initial thickness of the electrode, and the electrode was passed through the roller 5 times, varying direction for each pass.

The electrode tab was reinforced by applying clear Scotch packing tape to the back side of the electrode. Excess tape was removed with a scalpel blade.

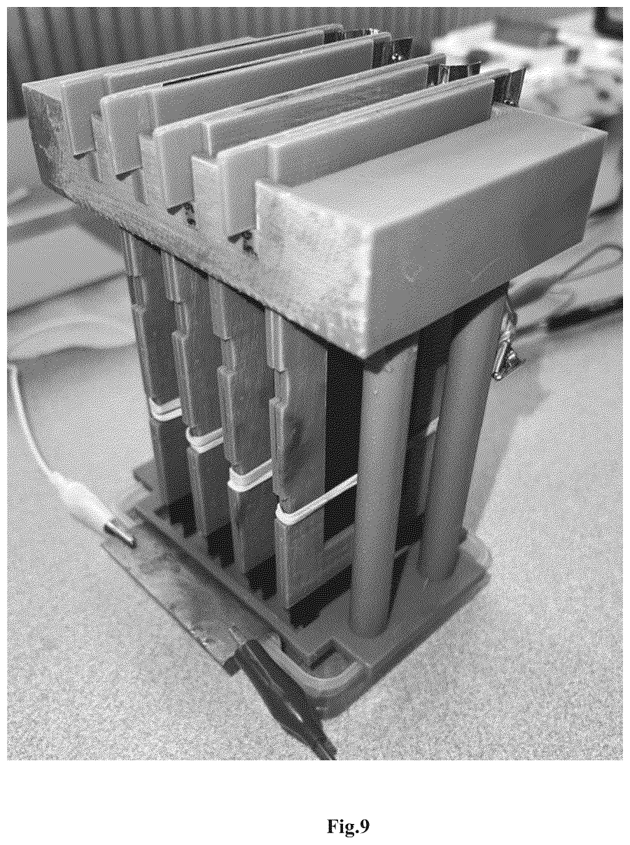

The type of contact present between supercapacitor electrodes and electrical leads is an important contributor to the device's resulting performance, specifically to the equivalent series resistance (ESR), which is the most significant parameter controlling device power capabilities. To decrease ESR, a copper (Cu) thin film (5-10 μm) was plated on the electrode tab using an electrodeposition technique. A metallic “tab” is required for soldering/welding an electric terminal to the device with minimal ESR, and Cu has been utilized. To increase productivity, a set up for Cu thin film electroplating of electrode tabs on multiple electrodes was designed, FIG. 9. This set up can accommodate four electrodes at once. The electrode tab was immersed 0.5 cm in the plating solution, giving a plating area of 0.25 cm² (=0.5 cm×0.5 cm). A Cu plating solution specially designed for soldering in microelectronics was introduced, the composition of which was taken from literature[18, 19]. The composition of the Cu plating solution consists of 0.26 M CuSO4 (copper sulfate), 2 M H2SO4 (sulfuric acid), 1.13 mM HCl (hydrochloric acid), 0.02 mM PEG (Poly(ethylene glycol)) (Mw 4000), and 0.01 mM SPS (bis(3-sulfopropyl) disulfide). During deposition, a current density of 20 mA/cm² was used, and the time was chosen to deposit equivalent 10 μm thick layer of Cu. After deposition, the tabs were washed with water and dabbed dry with a paper towel.

Before soldering, the Cu plated tabs were allowed to air dry for at least 24 hours. For soldering, 15 mm long, 1 mm thick Cu wire was used. The soldering iron was set 330° C., and a small amount of resin flux was applied to the Cu plated tabs before soldering the Cu wires.

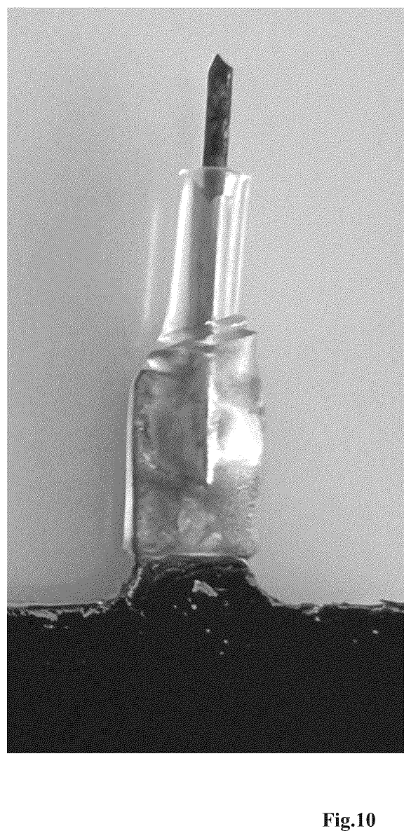

Corrosion of the electrical contact between the electrical leads and the Cu coated current collector tabs is yet another source of ESR. Although there is no physical contact between the Cu coated current collector tabs with HCl soaked active material or separator, driven by concentration gradient, Cl⁻ ions diffuse across the graphite surface towards the Cu tabs (capillary effect, or wicking). For protection against corrosion, the Cu contact was covered with a Si-based dielectric grease and then encapsulated with heat shrink tubing, FIG. 10.

### 5. Specifications of Electrolyte and Separator

The high-energy and high-power supercapacitor invention relies on the pseudocapacitive nature of the state-of-the-art PANI-PBC nanocomposite synthesized, where ion transport to and from the electrolyte and the electrodes is crucial for operation. Aqueous (0.5M HCl) electrolyte was used for fabricating devices in the 0.8-1V potential window per supercapacitor cell.

The aqueous electrolyte is limited to a single cell voltage of 1.2V due to onset of electrolysis, resulting in the formation of hydrogen and oxygen gas.

As a separator, glass fiber filter was used. It is 260 μm thick, has a 1.6 μm pore size, and contains no binder.

### 6. Assembly of Supercapacitor

The assembly procedure is as follows. The positive and negative electrodes are pre-soaked with aqueous 0.5M HCl for 5 min. Then, the glass fiber separator is placed on one of the electrodes and is soaked with aqueous 0.5M HCl. After that, the electrodes were assembled face-to-face, with the separator in between. The whole supercapacitor assembly was secured by wrapping plastic adhesive tape around it for easier handling during the packaging procedure described below.

### 7. Packaging of Supercapacitor

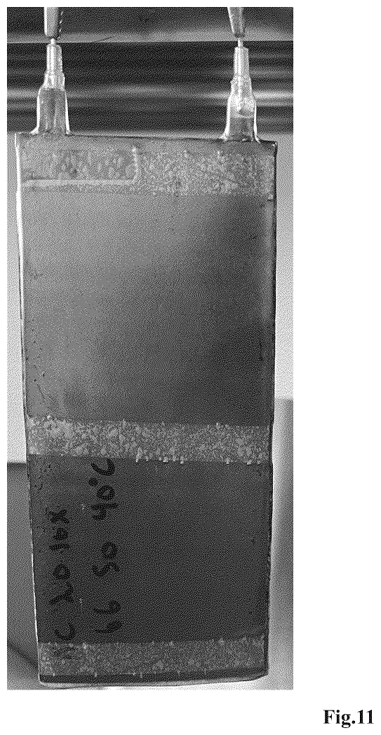

The assembled supercapacitor invention may be packaged using a variety of methods and materials (epoxy, torsion metal/plastic casing, laminated metal/plastic pouches, coin cells, rolled cylindrical canisters) and packaging environments (inert or ambient atmosphere or vacuum). Device packaging considers complete sealing such that the electrolyte does not evaporate, and the exterior environment does not penetrate the supercapacitor interior, resulting in reduced electrochemical performance. Packaging should ensure the electrolyte or active material does not corrode device leads or current collectors. In order that the supercapacitor invention attain flexible properties, the device encasing should be made of flexible materials. FIG. 11 shows the supercapacitor invention after casting in a flexible rubberized coating. The device returns to its initial form after being flexed without any losses in performance, given the flexible nature of the nanocomposite electrodes and electrolyte materials. Hence, the supercapacitor invention here-in possesses a high form factor, and device fabrication may be performed in any custom-tailored geometry appropriate for the desired application (dome, cylinder, planar, box-formed devices, among others).

### 8. Supercapacitor Testing

A variety of testing procedures have been established for testing supercapacitors electrochemical performance. A description of a variety of techniques used for detailing the performance characteristics of the supercapacitor invention here-in is described.

Leakage current is defined as is the small amount of current that continues to flow when a capacitor is fully charged, and the rated voltage is still applied.

Open circuit potential monitoring may be performed after the device has been charged to its operating voltage. Open circuit potential was monitored by recording voltage drop after the supercapacitor was disconnected from its main charging source. This testing offers direct insight into the self-discharge characteristics of the device as it discharges to its rest state.

Cyclic voltammetry (CV) potential-dynamic tests are typically performed to evaluate the specific electrochemical behavior of energy devices. A constant voltage scanning rate (1-100 mV/s) is used to evaluate the current response of the device within its operating voltage window. This test is used to measure capacitance as well as to confirm the capacitive behavior of the device.

Galvanic charge/discharge (GCD) test is commonly performed to evaluate the capacitance, equivalent series resistance (ESR), energy, and power density of supercapacitors in the form of a Ragone plot. Constant charging and discharging currents are applied to analyze the supercapacitor voltage response. In these tests, a holding time of 1 hour at operating voltage was used to ensure the device is saturated at its operating voltage. The resulting linear slope of the discharge current-voltage data is indicative of device capacitance. Sudden voltage drops during discharge in the order of micro-seconds are the result of equivalent series resistance (ESR). Power and energy density are calculated from the measured capacitance and ESR. This test may be conducted using repeated cyclic charge discharge experiments to understand the stability of the device.

Electrical impedance spectroscopy (EIS) may be performed for analysis of the devices phase lag to a sinusoidal input voltage varying from high to low frequency. Both Nyquist and Bode plots are extracted from this analysis to interpret the physical, chemical, and electrical mechanistic transport phenomena and resulting electrochemical performance properties (conductivity, capacitance, equivalent series resistance (ESR), ion diffusivity, redox kinetics, etc. of the supercapacitor device.)

State of charge experiments (SOC) are performed using repeated charge/discharge cycles to ensure the fabricated supercapacitors have a usable and sufficient cycling life. The capacitance after each charge/discharge cycle may be computed and compared for investigating losses in capacity. Typical causes of losses in capacitive performance are due to corrosion, electrolyte evaporation/decomposition, oxidative degradation of PANI, and reduced electrode-active material adhesion causing poor electrical conductivity.

### 9. Supercapacitor Performance

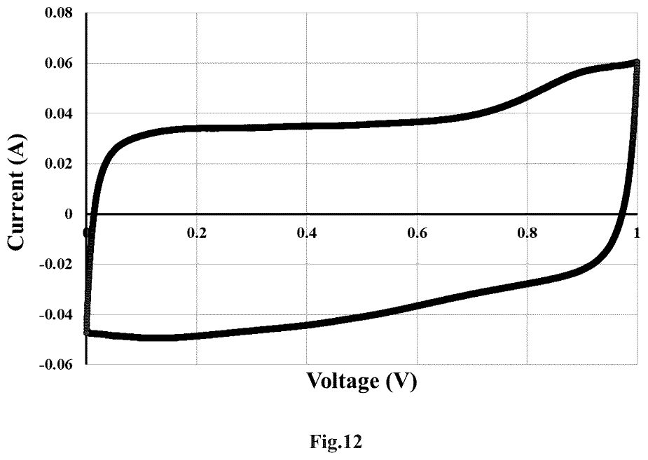

Cyclic voltammetry experimental data observed for 0.5M HCl aqueous electrolyte PANI-PBC cathode, AC anode supercapacitor with 8 mg/cm² (1.4 g total) mass loading using a scan rate of 1 mV/s may be seen in FIG. 12. The CV curve has a rectangular shape, symmetry about the zero current axis, and near-vertical current transitions at the extremes of the voltage window, all of which are indicative of capacitive behavior.

Typical GCD experiments performed to evaluate capacitance and ESR uses charge/discharge currents equal to 0.05 A/g (70 mA for 1.4 g) of the total active material mass of both anode and cathode. Capacitance and ESR were obtained from GCD experiments conducted at 1V. GCD were performed as following: First, the supercapacitor is charged to 1 V at 0.05 A/g, after which the voltage was held constant at 1 V for 1 hour. Then, the supercapacitor was discharged at 0.05 A/g. This cycle was repeated 3 times. The capacitance and ESR were calculated from the discharge curves, and the presented value is the average of the 2^{nd} and 3^{rd} cycle. The measured capacitance is 45.64 F, and the ESR is 0.35Ω. It is noted that measured device capacitance will change with changing charge/discharge operating currents used during GCD testing and various testing protocols will result in performance differences.

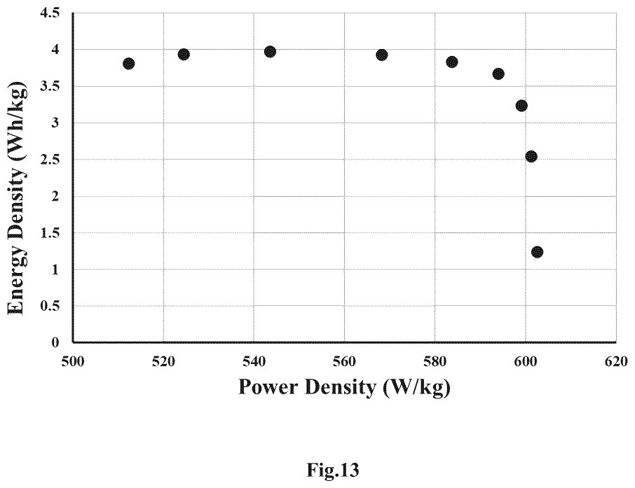

GCD measured specific capacitances of the supercapacitors tested reveal specific capacitance of 45.32 F/g. The supercapacitor shows specific energy performance up to a maximum of 6.3 Wh/kg with high specific power up to 245 W/kg. A Ragone plot representing energy v. power density is shown in FIG. 13. It is important to note that the mass used for device specific capacitance is that of the active solid-state nanocomposite deposited on the chosen electrodes.

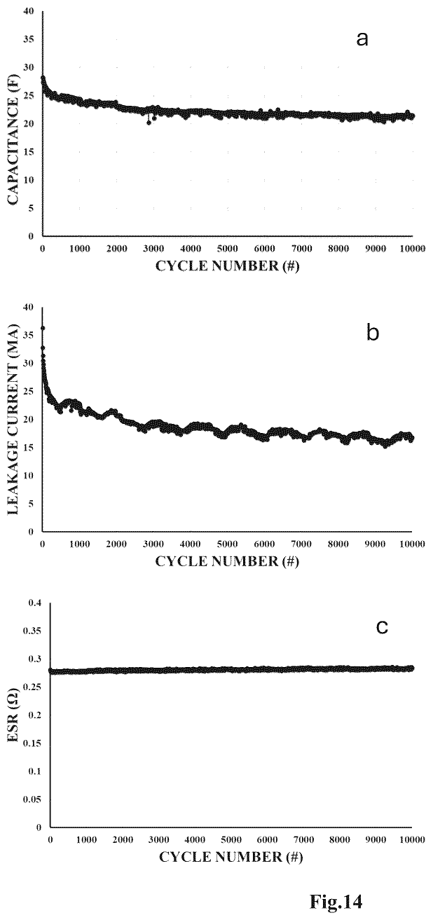

The fabricated, single-cell, flexible supercapacitors show stability for >10,000 GCD cycles under the following conditions: Charge/discharge current=0.45 A/g (0.63 A), working voltage=1 V. The stability of our supercapacitors is reflected by the fact that there is no catastrophic decline in properties, more specifically, capacitance does not drop by more than 20 and ESR and leakage current did not double, FIG. 14 (a,b,c).

Leakage current was measured by charging the supercapacitor to 1V at 0.05 A/g, then holding the voltage constant for 72 hours. The leakage current measured after 72 hours is 2 mA (1.4 mA/g). This is equivalent to 2.86% of the charging current.

Open circuit potential measurements were performed immediately after leakage current measurement, and open circuit potential was monitored for 72 hours. The open circuit potential measured after 72 hours is 0.344 V, and the time required for the supercapacitor to discharge to ½ working voltage (0.5 V) is 34 hrs, 36 mins.

### REFERENCES

### Addin En.Reflist

1. Şahin, M. E., F. Blaabjerg, and A. Sangwongwanich, A comprehensive review on supercapacitor applications and developments. Energies, 2022. 15(3): p. 674.
2. Alamro, T. and M. K. Ram, High specific capacitance solid state supercapacitor and method of manufacture. U.S. Pat. No. 11,631,551, issued dated on 18 Apr. 2023
3. Alamro, T. and M. K. Ram, High specific capacitance solid state supercapacitor and method of manufacture. U.S. Pat. No. 11,127,539 issued on 21 Sep. 2021
4. Takshi, A. and M. K. Ram, Smart thermal management system to prevent thermal runaway in rechargeable batteries. Patent application 2 US 2023/0420766 A1; PCT/US21/47454; WO 2022/046841 A1; [symbol] 2023-539671 (P2023-539671A); CN 116420; [symbol] 10-2023-0110716 5. published on 28 Dec. 2023.
5. González, A., et al., Review on supercapacitors: Technologies and materials. Renewable and sustainable energy reviews, 2016. 58: p. 1189-1206.
6. Sahin, M. E., F. Blaabjerg, and A. Sangwongwanich, A review on supercapacitor materials and developments. Turkish Journal of Materials, 2020. 5(2): p. 10-24.
7. Aljafari, B., et al., Photo-electric properties of polypyrrole based gel electrolyte for hybrid photoactive supercapacitors. ECS Transactions, 2019. 92(9): p. 7.
8. Gómez, H., et al., Graphene-conducting polymer nanocomposite as novel electrode for supercapacitors. Journal of Power Sources, 2011. 196(8): p. 4102-4108.
9. Basnayaka, P. A., et al., Supercapacitors based on graphene-polyaniline derivative nanocomposite electrode materials. Electrochimica Acta, 2013. 92: p. 376-382.
10. Basnayaka, P. A. and M. K. Ram, A review of supercapacitor energy storage using nanohybrid conducting polymers and carbon electrode materials. Conducting Polymer Hybrids, 2017: p. 165-192.
11. Basnayaka, P. A., et al., High performance asymmetric supercapacitors based on dual phosphorus (P) and nitrogen (N) co-doped carbon and graphene-polyaniline electrodes. ECS Journal of Solid State Science and Technology, 2017. 6(6): p. M3168.
12. Alamro, T. and M. K. Ram, Polyethylenedioxythiophene and molybdenum disulfide nanocomposite electrodes for supercapacitor applications. Electrochimica Acta, 2017. 235: p. 623-631.
13. Ram, M. K., Coal derived solid state supercapacitor cells. 2021, Google Patents.
14. Khawaja, Moh, M. K. Ram, et al., Sol-gel synthesis of ruthenium oxide-graphene nanocomposites as electrode material for supercapacitor applications. Graphene, 2014. 2(2): p. 117-122.
15. Wang, Z., et al., Cellulose-based supercapacitors: material and performance considerations. Advanced Energy Materials, 2017. 7(18): p. 1700130.
16. Pérez-Madrigal, M. M., M. G. Edo, and C. Alemán, Powering the future: application of cellulose-based materials for supercapacitors. Green Chemistry, 2016. 18(22): p. 5930-5956.
17. Jiao, F., et al., Nanofibrillated Cellulose-Based Electrolyte and Electrode for Paper-Based Supercapacitors. Advanced sustainable systems, 2018. 2(1): p. 1700121.
18. Liu, Y., et al., Improving copper electrodeposition in the microelectronics industry. IEEE Transactions on Components and Packaging Technologies, 2009. 33(1): p. 127-137.
19. Wafula, F., et al., Impact of key deposition parameters on the voiding sporadically occurring in solder joints with electroplated copper. Journal of The Electrochemical Society, 2009. 157(2): p. D111.

What is claimed is:

1. The invention is on supercapacitor comprising of a cathode with binder on graphite electrode, anode with binder on graphite electrode and electrolyte soaked in a glass separator where asymmetric devices are fabricated, exploiting three primary electrode materials for high power performance and stability.

2. The materials of claim 1 in cathode which is composed of conducting polymer of emeraldine form of polyanilines such as polyaniline, poly(methyl polyaniline), poly (ortho-anisidine), poly(ortho-toluidine) and their combination)), composite with pyrolyzed bacterial cellulose with carboxymethyl cellulose as binder.

3. The materials of claim 1 in anode which is composed of activated carbon, pyrolyzed cellulose (methyl cellulose, hydroxyethyl cellulose, ethyl hydroxy cellulose, carboxymethyl cellulose, nano-cellulose and their combination) as the active material with carboxymethyl cellulose as the binder.

4. The materials of claim 1 in cathode is prepared by slurry is preparation by mixing aniline and PBC in a beaker with appropriate amounts of hydrochloric acid (HCl), isopropyl alcohol (IPA), and de-ionized water (DI) at about 5° C. by immersing the beaker in an ice bath. The slurry is mixed until a homogenous liquid solution is produced. Approximate volume ratios of HCl, IPA, and DI to that of monomer (aniline, methyl aniline, toluidine, ethoxyaniline) with monomer to 10 wt. % of PBC in the final composite product. Part B solution is made with ammonium persulfate (˜0.3 g/mL) (APS) dissolved in appropriate amounts of hydrochloric acid and de-ionized water. The volume ratio of HCl to DI in this part B solution is typically 0.09. Forced mixing is used for preparing all solutions.

5. The materials of claim 1 in cathode comprised of conducting polymer (polyaniline, poly(methyl polyaniline), poly (ortho-anisidine), poly(ortho-toluidine) and their combination)), for the pseudocapacitive nanocomposite is formed through the slow dripping (˜1 drop/4 sec) of the part B solution into the part A slurry and subsequent polymerization of conducting polymer. This reaction takes place immersed in an ice bath. After the completion of the reaction, the green and crystalline emeraldine base-PBC composite is precipitated out of solution and is separated using a vacuum filtration funnel.

6. The materials of claim 1 for anode and cathode utilize high char density and surface area carbon from pyrolyzed cultured celluloses from bacteria such as that produced by Gluconacetobacter xylinum (G. xy.).

7. The materials of claim 1 of anode comprised of cellulose material is pyrolyzed in a furnace under an inert atmosphere using nitrogen gas, where the furnace operating temperature is set between 200-600° C. with residence times sufficient for complete chemical and microstructural transformation.

8. The materials in claim 1 of anode and cathode of are comprised of high surface area, granular, polymer-pyrolyzed bacterial cellulose nanocomposites and activated carbon ultrasonically spray deposited on graphite current collectors under an elevated temperature (at or under 80° C.) to allow for solvent evaporation.

9. The materials in claim 1 of anode and cathode electrodes are cut to the desirable size required to assemble them into supercapacitors using a cutter for reproducibly cutting electrodes. It consists of a guide (top part) and cutting board (bottom part).

10. The materials in claim 1 of anode and cathode were hot (80° C.) rolled by sequentially increasing the pressure applied on the electrodes by decreasing the distance between the heated cylinders. The distance between the rolling cylinders was first set to 66%, then 50%, and finally 33% of the initial thickness of the electrode, and the electrode was passed through the roller 5 times per distance, varying direction for each pass.

11. The materials in claim 1 of anode and cathode, the electrodes was reinforced by applying clear Scotch packing tape to the back side of the electrode. Excess tape was removed with a scalpel blade.

12. The materials in claim 1 of anode and cathode based electrode are plated by copper (Cu) thin film (5-10 μm) using an electrodeposition technique to enable soldering copper wire leads onto the electrodes, thus ensuring minimal ESR. During deposition, a current density of 20 mA/cm2 was used, and the time was chosen to deposit equivalent 10 μm thick layer of Cu. After deposition, the tabs were washed with water and dabbed dry with a paper towel. Copper wire (15 mm long, 1 mm thick) was soldered to the copper plated electrode tabs. Copper tabs and soldered copper wire leads were protected against corrosion by covering the tabs with a Si-based dielectric grease and then encapsulated with heat shrink tubing.

13. The materials in claim 1 of anode and cathode electrodes are separated by a glass fiber filter separator of is 260 μm thick, has a 1.6 μm pore size, and contains no binder.

14. The materials in claim 1 of anode and cathode coated electrodes are aligned and sandwiched over the electrolyte—(The electrolyte is based on acidic solution (HCl, H2SO4, HNO3, CH3COOH and combination) socked in glassy fiber with porosity of maximum 1.6 μm. The supercapacitor invention utilizes aqueous (0.1 to 1M) HCl) soaked glass fiber separator and was secured by wrapping plastic adhesive tape around it for easier handling during the packaging procedure.

15. The materials in claim 1 of anode and cathode can be prepared by solution casting, ultrasonic sprayer and electrochemical deposition technique.

16. The supercapacitor of claim 1 is packaged by casting in a flexible rubberized coating flexible rubberized coating such as Plastidip. Flexseal and similar products besides the biodegradable polymer such as polylactic acid.

17. The independent claim is the use of supercapacitor can be used electric vehicles, medical devices and equipment, defense, detection and communication equipment, household appliances, wearable and consumable electronics, vertical takeoff and landing aircraft (VTOL), urban air mobility (UAM).
